(19) United States
(12) Patent Application Publication
(10) Pub. No.: US 2025/0245212 A1
(43) Pub. Date: Jul. 31, 2025

(54) CUSTOMIZED ANOMALY MONITOR FOR COMPUTE SYSTEM PERFORMANCE METRICS

(71) Applicant: Microsoft Technology Licensing, LLC, Redmond, WA (US)

(72) Inventors: Jeffrey Xin LI, Kirkland, WA (US); Minghua MA, Beijing (CN); Yu KANG, Shanghai (CN); Chaoyun ZHANG, Beijing (CN); Qingwei LIN, Beijing (CN); Yingnong DANG, Sammamish, WA (US); Cong CHEN, Sammamish, WA (US)

(21) Appl. No.: 18/428,627

(22) Filed: Jan. 31, 2024

(51) Int. Cl. G06F 16/23

(52) U.S. Cl. CPC G06F 16/2365

(57) ABSTRACT

An anomaly monitor customization tool executes a selected subset of backend anomaly detectors to process a time-series dataset for a performance metric and receives, from the backend anomaly detectors, anomaly report data identifying a first set of events included in the time-series dataset and flagged as anomalies and characterizes the anomalies by assigning anomaly type classifiers. An alert rule is generated based on feedback pertaining to discrepancies between the first set of events flagged as anomalies and a second set of events in the time-series dataset that are of interest to the user, and the alert rule is used to generate modified configuration data that is, in turn, used to provision a customized anomaly monitor.

### BACKGROUND

Large-scale cloud services are comprised of complex software and hardware components. In these environments, end users of a given cloud service may experience service disruptions due to a myriad of issues that originate at different locations within the vast cloud network supporting the service. For example, a cloud-based service provider may deploy instances of an offered consumer service on clusters of virtual machines provisioned by a cloud compute platform, and service-interrupting events can originate in the workflows of the underlying compute platform provide or the workflows of the service provider. Examples of service-interrupting events include software bugs (e.g., bug encountered during VM provisioning of the cloud compute platform or within the workflows of the cloud service provider) as well as production-level traffic that can contribute to latencies, connectivity interruptions at the internet service provider level, and more. Due to the complex nature of cloud-based service architectures, it is common for cloud service providers to rely, at least in part, on various monitoring services to aid in the detection of anomalies impacting the service provider's network.

Despite the existence of numerous anomaly detection algorithms proposed for cloud services over recent years, deploying monitors to a given cloud service remains a significant challenge largely on account of the diverse nature of workflows associated with different service offerings that give rise to different telemetry characteristics that cannot be consistently interpreted by bright line rules. For example, a specific characteristic observable in the time-series telemetry data may signify a potential problem (e.g., service interruption) if observed within the network telemetry of one service provider and not be indicative of a potential problem if observed within the network telemetry of another service provider.

Currently, selecting and applying monitors for a given service quality metric requires manual and iterative tuning of the internal parameters of available anomaly detection algorithms as well as tuning of various detection thresholds, which is extremely time consuming and complex enough to deter many technical administrators from seeking out the best-performing detectors and configurations with respect to the specific needs of a given cloud service provider. Often, the monitors ultimately selected for implementation have overly-simple configurations with static thresholds. These configurations are easy to set up and understand but unsatisfying in terms of performance on account of being either overly conservative when triggering alarms (and therefore resulting in long datasets that need to be manually spot-checked) or by simply failing to detect anomalous events that the service provider is interested in.

### SUMMARY

According to one implementation, an anomaly monitor customization tool executes a first instance of an anomaly monitor that defines a selected subset of backend anomaly detectors to process a time-series dataset for a performance metric. The anomaly monitor customization tool receives, as output from the instance of the anomaly monitor, anomaly report data identifying a first set of events included in the time-series dataset and flagged as anomalies and characterizes the anomalies by assigning anomaly type classifiers. The anomaly monitor customization tool defines an alert rule based on user feedback pertaining to discrepancies between the first set of events flagged as anomalies and a second set of events in the time-series dataset that are of interest to the user. The alert rule identifies a subset of the anomaly type classifiers and a rule enforcement action to be performed with respect to events within the time-series dataset characterized by the subset of the anomaly type classifiers. The alert rule is used to generate modified configuration data for the anomaly monitor and a customized anomaly monitor is provisioned based on the modified configuration data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system including a monitor recommendation and customization tool configured to generate a customized anomaly monitor for a cloud service provider.

FIG. 2 illustrates an example system including an anomaly detector recommender that recommends a specific configuration for an anomaly monitor to deploy within a service network of a cloud service provider.

FIG. 3 illustrates aspects of an example anomaly monitor customization tool that generates an initial anomaly report based on an initial anomaly monitor configuration.

FIG. 4 illustrates examples of anomaly characteristics that can be classified and used to develop alert logic implemented by a customized anomaly monitor.

FIG. 5A illustrates operations of another example system that implements an anomaly monitor customization tool to drive a tuning cycling for iterative, feedback-based configuration of a customized anomaly monitor.

FIG. 5B illustrates example operations performed by the anomaly monitor customization tool of FIG. 5A during a detector tuning cycle that is commenced in response to receiving user feedback.

FIG. 5C illustrates example operations of the anomaly monitor customization tool of FIGS. 5A and 5B for provisioning a customized anomaly monitor for the end user based on one or more iterations of the tuning cycle discussed with respect to FIGS. 5A and 5B.

FIG. 6 illustrates an example schematic of a processing device suitable for implementing aspects of the disclosed technology.

### DETAILED DESCRIPTION

The herein disclosed technology includes a software tool backed by an artificial intelligence model that recommends and/or iteratively tunes a configuration for an anomaly monitor to provide a customized monitoring solution tailored to generate alerts in response to observing telemetry characteristics that are of interest to a cloud service provider. According to one implementation, the software tool analyzes user inputs to recommend an initial anomaly monitor configuration and implements a user-friendly feedback loop that drives a complex backend tuning cycle to optimize detector selection, parameter selection, threshold selection, and additional alert logic to generate anomaly reports customized to the unique needs of the service provider.

The herein-disclosed customized anomaly monitor can be deployed within the network of a cloud service provider to provide a rate of detection capability for telemetry events characterized by the types of features that the cloud provider is most interested in detecting. The customized anomaly monitor derived for the cloud service provider is, for example, characterized by collection of backend anomaly detectors (e.g., executed sequentially or in tandem), detector parameters, detector thresholds, and/or additional alert logic implemented on outputs of the backend anomaly detectors to provide a final set of anomaly detection results to the cloud service provider. Further benefits and implementation details are explored with respect to the figures.

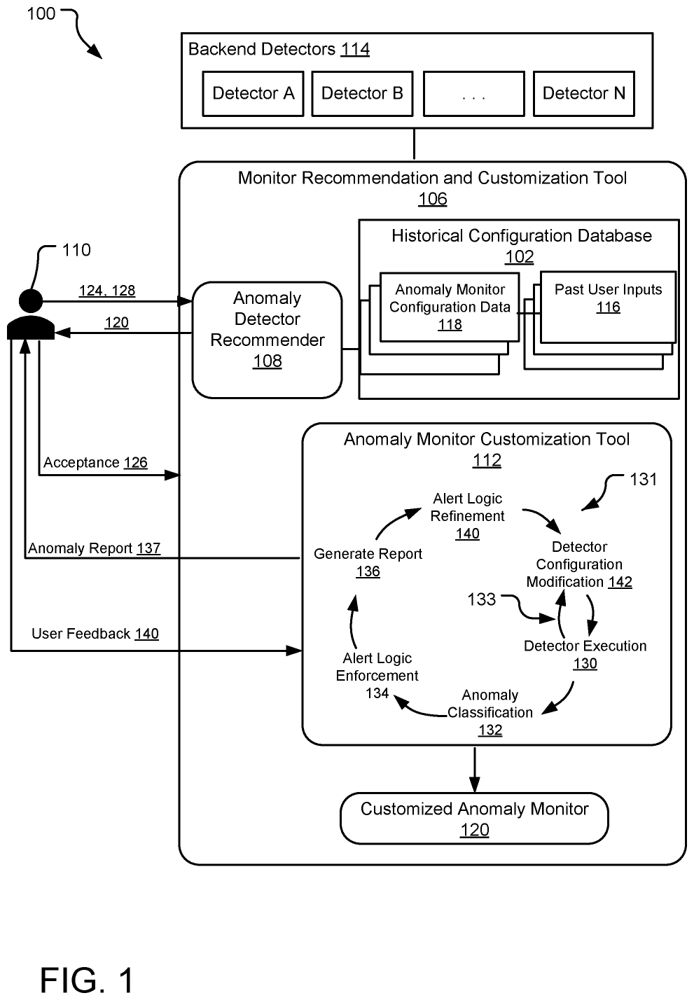

FIG. 1 illustrates an example system 100 including a monitor recommendation and customization tool 106 configured to generate a customized anomaly monitor 120 for a cloud service provider. The monitor recommendation and customization tool 106 is shown to include an anomaly detector recommender 108 that recommends an initial configuration for an anomaly monitor as well as an anomaly monitor customization tool 112 that performs actions for tuning the recommended configuration to for better enforcement of the monitoring objectives of the cloud service provider.

Notably, some implementations of the disclosed technology provide for recommending an anomaly monitor configuration without tuning of the recommended configuration and therefore include the anomaly detector recommender 108 and not the anomaly monitor customization tool 112. Other implementations of the disclosed technology provide customization of a monitor configuration that is provided as an input to the tool (e.g., by the cloud service provider) rather than recommended. These implementations include the anomaly monitor customization tool 112 and not the anomaly detector recommender 108.

The monitor recommendation and customization tool 106 is a software tool usable, for example by an administrator 110 of a cloud-based service, to configure a customized anomaly monitor 120 uniquely suited to detect and flag (e.g., generate alerts for) telemetry events that are of interest to the service provider. In various implementations, the cloud-based service offers diverse functionality to end users, for example, cloud-based data processing tools, code development platforms, media streaming services, trained AI models, retail services facilitated by software, etc. The cloud-based service is delivered a service network (not shown) that includes one or more servers configured to execute workflows of the service provider, one or more end user devices, and communication channels between the server(s) and the user devices. In some implementations, the service network further includes a network of virtual machines (VMs) that execute the workflows on behalf of the service and a network of cloud-provider servers that provision and maintain the VMs. Within this construct, the cloud-service provider receives and monitors various performance metrics (e.g., quality metrics in the form of time-series telemetry) that pertain to the functionality of the service network as a whole and/or of individual subcomponents and flows within the service network, including metrics describing performance of individual compute nodes, and data storage components.

As shown in FIG. 1, the administrator 110 selectively provides the time-series data for the performance metric 124 as one input to the monitor recommendation and customization tool 106. In general, the time-series data for the performance metric 124 can be understood as including time-series measurements that provide real-time insights into potential issues, outages, latencies, and errors experienced within the service network of the service provider. Examples of performance metrics include measurements of latencies (e.g., server response times and round-trip travel (RTT) times for peer-to-peer connections), CPU utilization on server(s) (or VMs) within the service network, bandwidth usage (e.g., the maximum data transmission rate on a network at a particular time), packet loss, packet retransmission rates, throughput in various areas of a network, network availability or “uptime” (e.g., an indication of how much of the service network is available over a specific time interval), connectivity, jitter, and more.

In various implementations, the administrator 110 of the cloud-service provider obtains the time-series data for the performance metric 124 in different ways such as by installing one or more network monitoring tools designed to specifically measure such metrics and/or by subscribing to other cloud-based services that provide the network quality metrics. In one implementation where the service network is supported by virtual machines provisioned by third-party cloud provider, the third-party cloud provider supplies the network time-series data for the performance metric 124 to the cloud service provider.

Notably, different types of cloud service providers may be more interested in monitoring some performance metrics more closely than others. For example, workflows pertaining to services positioned higher in the architecture stack a cloud-based compute platform may be highly susceptible to latency metrics that look like anomalies that are actually false alarms due to the fact that these services have touchpoints across many different parts of the cloud compute environment. For this reason, an administrator of one of these services may not wish to receive latency-related alerts. In contrast, services positioned lower in the architectural stack of a cloud-based compute platform (e.g., node level services that provide the virtual machines for higher level services) may be less susceptible to the above-described false alarms and therefore much more interested in receiving latency alerts. These differences in the types of performance metrics that are of interest to different cloud service providers give rise to customized telemetry monitoring needs.

Notably, the diverse service offerings and network architectures of different service networks can also lead to differences in the characteristics and patterns observed within the time-series data for a given performance metric. Telemetry characteristics indicative of a potential problem within the network of one service provider may be indicative of nominal (non-problematic) operations for another service provider. If, for example, one service provider performs a high overhead workload at a time on the last day of every month, then it may be normal for the service provider to observe an average CPU utilization that is 85% or more on the last day of the month. In contrast, the same CPU utilization could be indicative of a network problem for another service provider (or even for the same service provider if the high CPU utilization were observed on a different day of the month).

As is discussed further below, the recommendation and customization tool 106 performs customized recommendation based on user inputs and feedback-driven customized tuning to derive an instance of anomaly monitor (e.g., the customized anomaly monitor 120) that is tailored to high-performance with respect to specific detection needs of the cloud-service provider. As used herein, the term “anomaly monitor” refers to a body of executable logic that performs anomaly monitoring on network telemetry by selectively executing various backend anomaly detectors 114 (e.g., Detector A, Detector B, . . . . Detector N) according to a specific configuration of parameters and thresholds and, in some cases, by implementing additional alert logic that provides for independent analysis and modification of report data generated by the various anomaly detectors to ensure final outputs reflect adequate enforcement of alert rules derived from user inputs.

The backend anomaly detectors 114 are software-based models configured to process time-series data and to detect and classify events observed within the time-series data using different algorithmic approaches and/or trained machine learning models. In the present application, it is assumed that the anomaly detectors are each configured to classify telemetry events as being “anomalous” (e.g., flagging the event with an alert) or non-anomalous; however, it is to be appreciated that this capability can be realized by specific configurations of many models. Examples of model types widely employed as anomaly detectors include models based on the Isolation Forest (Iforest) algorithm, models employing the K-nearest neighbor (KNN) algorithm (KNN), the LODA (lightweight on-line detector of anomalies) model, and more.

In various implementations, the backend anomaly detectors 114 are physically stored and at the same or different locations. For example, select detectors of the backend anomaly detectors 114 may physically reside on the same or different compute devices (e.g., servers) and such compute devices may be physically located at the same or different facilities (e.g., data centers). Some or all of the backend anomaly detectors are implemented at cloud-based endpoints reachable by employing an appropriate application programming interface (API).

In FIG. 1, the administrator 110 of the cloud service network provides time-series data for a performance metric 124 of interest to the monitor recommendation and customization tool 106 along with a description 128 (e.g., a natural language description) of the performance metric 124 and/or that indicates specific information that the user would like to receive in an anomaly report (e.g., types of data to be plotted/visually rendered to the user or specific characteristics of events that the user would like to see flagged as anomalies). The time-series data for the performance metric 124 include at least one time-series dataset (e.g., a latency metric computed hourly for one day) and may include multiple different datasets pertaining to different performance metrics.

In response to receiving the time-series data for the performance metric 124 and the description 128, the anomaly detector recommender 108 accesses a historical configuration database 102 that stores historical configuration data pertaining to previous configurations of the anomaly monitor provisioned for different users. Each historical configuration of the anomaly monitor in the historical configuration database 102 stores past user inputs 116 (e.g., inputs provided by a past user) and anomaly monitor configuration data 118 that reflects a configuration of the anomaly monitor configured on behalf of the customer. In one implementation, the past user inputs 116 include performance metric(s) and/or a description of metrics of interest and/or events of interest (e.g., events to be flagged as anomalies).

The anomaly detector recommender 108 compares inputs from the administrator 110 (e.g., the time-series data for the performance metric 124 and/or description 128) to the past user inputs 116 stored in association with each historical configuration and from this, identifies a “most relevant historical configuration”—e.g., an identified historical instance of the anomaly monitor that was configured for a user based on past user inputs identified as being “most similar” to the presently-received user inputs (e.g., the inputs received from the administrator 110). The anomaly detector recommender 108 then provides the administrator 110 with a recommended configuration for an anomaly monitor (shown as customized anomaly monitor 120) that is based on the anomaly monitor configuration data 118 stored with respect to the identified most relevant historical configuration. The recommendation 120 includes at least a selected subset of the backend anomaly detectors 114 and, in some implementations, further includes initial values for detector parameter(s) for the backend anomaly detectors 114, initial value(s) for detector thresholds, and additional alert logic (e.g., alert rules) that is to be executed on the outputs of the selected subset of the backend anomaly detectors 114.

In response to receiving an indication of acceptance 126 from the administrator 110, the monitor recommendation and customization tool 106 adopts the recommendation 120 as a starting point for configuring the customized anomaly monitor 122 on behalf of the administrator 110. An anomaly monitor customization tool 112 then executes a feedback-based loop 131 that drives a complex backend tuning cycle to optimize anomaly monitor configuration data for the customized anomaly monitor 122. As used herein, “anomaly monitor configuration data” refers to detector configuration data (e.g., selected detectors, detector thresholds, detector parameters) in combination with alert logic, some of which may be selectively enforced on outputs of the backend detectors 114.

Initially, the feedback-based loop 131 commences with a detector execution phase 130 that executes the selected subset of backend anomaly detectors on the time-series data for the performance metric 124. The detector execution phase 130 yields anomaly report data that that includes flags labeling a first set of events as “anomalies.” These events are referred to below as “the flagged anomalies.”

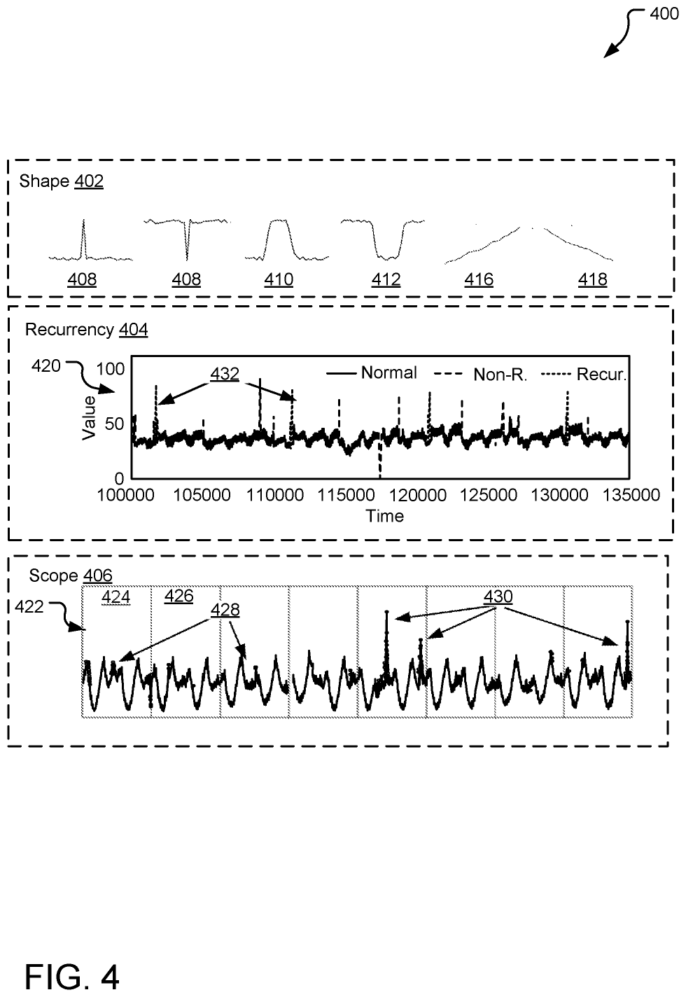

Following the detector execution phase 130, and anomaly classification phase 132 provides for analyzing physical characteristics of each of the flagged anomalies and assigns, based on the physical characteristics, one or more predefined anomaly type classifiers to each of the flagged anomalies. Examples of anomaly type classifiers include classifiers of anomaly shape (e.g., spike, dip), classifiers of anomaly scope (e.g., global, local) and classifiers pertaining to recurrency (e.g., recurring, non-recurring), all of which are discussed in greater detail with respect to FIG. 4.

Following the anomaly classification phase 132, an alert logic enforcement phase 134 enforces alert logic that has been defined (if any exists) for the currently-selected detector configuration. The alert logic may, for example, define specific enforcement actions to be taken with events characterized by specific combinations of the anomaly type classifiers, such as actions to include or exclude events characterized by different types of anomaly type classifiers from the flagged anomalies. The alert logic is, for example, defined by the recommendation 120 and/or derived from user feedback in subsequent iterations of the feedback loop 131.

In some iterations of the feedback-based loop 131, the alert logic enforcement phase 134 enforces filtering rules on anomaly report data generated by executing backend detectors (e.g., selected from the backend anomaly detectors 114) in accordance with the currently-selected detector configuration. For example, the alert logic may include an exclusion rule that provides for redacting anomalies characterized by select anomaly type classifier(s) from report data output to the administrator 110.

Following the alert logic enforcement phase 134, a report generation phase 136 generates and presents a report 137 (e.g., a visual representation of anomalies) to the administrator 110.

The administrator 110 provides feedback pertaining to discrepancies between the flagged anomalies and a set of events from the same time-series that the administrator is interested in receiving anomaly alerts for. For example, the feedback indicates that the administrator 110 would like to add a spike-shaped event corresponding to a user-specified timestamp to the list of anomalies or to remove events with a certain physical characteristic from the list of anomalies.

An alert logic refinement phase 140 refines existing alert logic based on the received user feedback. In some implementations, a trained natural language processing (NLP) model to is utilized to infer user intent from natural-language user feedback and/or to translate the natural language user feedback into new alert rules to be added to the alert logic.

A detector configuration modification phase 142 enforces inclusionary rules of the alert logic (e.g., rules for identifies events with certain specified characteristics as anomalies) by selecting a modified detector configuration that differs from an initial detector configuration by adding or removing select detectors from the selected subset of the backend anomaly detectors 114 and/or altering threshold(s) or parameter(s) of the backend anomaly detectors 114. The detector execution phase 130 executes a new instance of an anomaly monitory based on the modified detector configuration, and these configuration update/re-execution operations are iteratively performed (as shown by sub-loop 133) until a best-performing detector configuration is identified with respect to enforcement of the inclusionary rules.

If, for example, the user the provides feedback requests the addition of an event on a particular date to the listing of flagged anomalies, the alert logic refinement phase 140 adds an alert rule to this effect and the detector configuration modification phase 142 modifies the detector configuration to identify a new detector configuration that succeeds at identifying the event on the particular date as an anomaly. Once a best-performing detector configuration is identified with respect to the alert logic, the best-performing detector configuration is adopted and the sub-loop 133 is terminated. Anomalies are next classified by the anomaly classification phase 132, remaining alert logic (e.g., filtering rules) are enforced at the alert logic enforcement phase 134 (if any exist), and a new report is generated by the report generation phase 136.

In the above-described way, anomaly monitor configuration data is iteratively tuned via updates to alert logic (e.g., inclusion/exclusion rules) derived from user feedback. The alert logic may include inclusionary alert rules enforced by modifying the selected detector configuration during the detector configuration modification phase 142 and/or exclusionary alert rules enforced during the alert logic enforcement phase 134, such as by filtering or otherwise modifying anomaly report data generated by based on the selected detector configuration. Once a best-performing instance of the anomaly monitor configuration data is identified and the user ceases to provide feedback, the customized anomaly monitor 122 is provisioned for use based on the best-performing instance of the anomaly monitor configuration data.

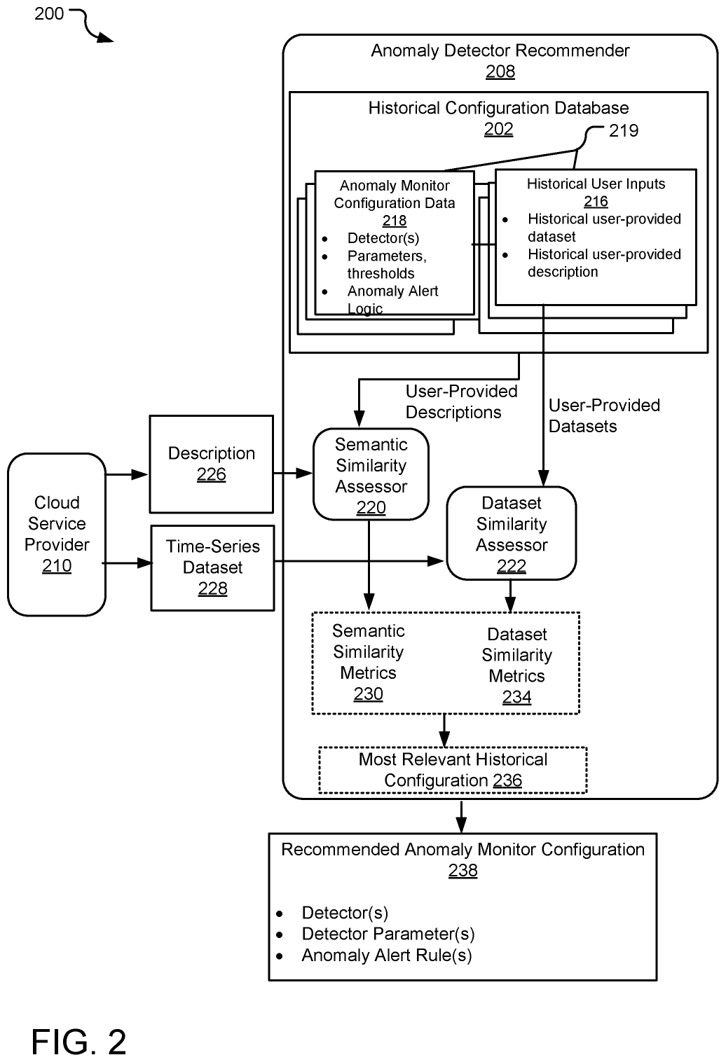

FIG. 2 illustrates an example system 200 including an anomaly detector recommender 208 that recommends a specific configuration for an anomaly monitor to deploy within a service network of a cloud service provider 210. Specific features of the anomaly detector recommender 208 not explicitly described with respect to FIG. 2 may be the same or similar to the anomaly detector recommender 108 in FIG. 1. In some implementations, the anomaly detector recommender 208 is integrated within a larger monitor customization system with aspects similar to FIG. 1.

As input, the anomaly detector recommender 208 receives from the cloud service provider 210, time-series dataset 228 for a performance metric measured within a service network of the cloud service provider. For example, the time-series dataset 228 includes measurements of peak server response time, reported hourly, for each server hosting data of the cloud service provider 210. As an additional input, the cloud service provider 210 provides a description 226 that identifies the performance metric corresponding to the time-series dataset 228 and/or that indicates type(s) of information that the user would like to receive in an anomaly monitor report. For example, the description 226 may indicate a type of metric that the cloud service provider 210 would like to be derived from the time-series dataset 228 and visually rendered in a report and/or specific characteristics that the cloud service provider 210 would like to see flagged as anomalies in an anomaly report.

For example, in the above-described scenario where the time-series dataset 228 includes hourly-reported peak server response time for several servers, the description 226 may read: “suggest the best algorithm for detecting the p50 time-series.” This description indicates that the user would like to receive an anomaly report that analyzes the median latency across all hosts for which the corresponding time-series data was collected.

In response to receiving the time-series dataset 228 and the description 226, the anomaly detector recommender 208 accesses a historical configuration database 202 that stores historical configuration data pertaining to previous configurations of an anomaly monitor provisioned for different end users (e.g., cloud service providers). Each historical configuration 219 stored in the historical configuration database 202 includes a pair of historical user inputs 216 provided by a past user and that also includes anomaly monitor configuration data 218 for the anomaly monitor configured on behalf of the corresponding end user. In the illustrated implementation, the historical user inputs 216 include a historical user-provided dataset (e.g., similar in form to the time-series dataset 228) and a corresponding historical user-provided description (e.g., similar in form to the description 226). The anomaly monitor configuration data 218 of FIG. 2 is shown to identify detectors (e.g., a selection of backend anomaly detectors executed by the instance of the anomaly monitor), detector parameters and/or thresholds (e.g., parameters of the detectors and/or thresholds enforced by the detectors), and anomaly alert logic enforced by the anomaly monitor as a whole.

The anomaly detector recommender 208 compares the description 226 and time-series dataset 228 (collectively, the referred to below as the “pair of user inputs”) to corresponding data types (e.g., the historical user-provided description and the historical user-provided dataset) for each of the stored historical configurations to predict a similarity between the target configuration the cloud-service provider is seeking and each of the historical configurations of the anomaly monitor.

In one implementation, the forgoing comparison is facilitated by computing two separate similarity metrics—a semantic similarity metric and a dataset similarity metric—with respect to each of the stored historical configurations of the anomaly monitor. These metrics are represented in FIG. 2 by semantic similarity metrics 230 and dataset similarity metrics 234. The semantic similarity metrics 230 each quantify similarity between the description 226 and the historical user-provided description of a select one of the stored historical configurations. Likewise, the dataset similarity metrics 234 each quantify similarity between the time-series dataset 228 and the historical user-provided dataset of a select one of the stored historical configurations. These two similarity metrics computed for each of the historical configurations are used, in combination, to identify a select one of the historical configurations as being a “most relevant historical configuration 236” with respect to the target configuration the cloud service provider 210 is seeking.

In FIG. 2, a semantic similarity assessor 220 is shown computing the semantic similarity metrics 230, which can be understood as including a semantic similarity metric computed between the description 226 and each of the user-provided descriptions in the historical configuration database 202. In one implementation, the semantic similarity assessor 2220 includes a trained semantic similarity model that vectorizes the description 226 and the historical user-provided description of each of the historical configurations. This vectorization operation translates each description into a vector defined within a common vector space in which each vector-to-vector separation correlates with a learned degree of semantic similarity of the vectors. The trained semantic similarity model is, for example, a transformer-based natural language model that learns context and thus meaning by tracking relationships in sequential data. Examples of transformer-based natural language models include sequence-to-sequence models, generative pre-trained transformer (GPT) models, and bidirectional encoder representations from transformers (BERT) models. Once re-defined within the above-described common vector space, a suitable comparative metric (e.g., dot product or cosine similarity) is employed to compute the semantic similarity metric between the description 226 and each of the historical user-provided descriptions, yielding the semantic similarity metrics 230.

Likewise, FIG. 2 also shows a dataset similarity assessor 222 that computes the dataset similarity metrics 234, which can be understood as including a dataset similarity metric computed between the time-series dataset 228 and each of the historical user-provided datasets in the historical configuration database 202.

For each different one of the stored historical configurations of the anomaly monitor, an overall similarity metric is computed based on both the associated semantic similarity metric and the associated time-series similarity metric. This overall similarity can be understood as indicative of a similarity between the target configuration of the cloud service provider 210 and each of the historical configurations. In one implementation, the overall similarity metric is given by: (α·(semantic similarity metric)+(1−α)·(dataset similarity metric)), where α represents a weight that balances the semantic similarity metric against the dataset similarity metric. The weight is, in some implementations, configurable by the end user.

Based on the overall similarity metric computed with respect to each of the historical configurations, a select one of the historical configurations is identified as being the most relevant historical configuration 236.

The anomaly detector recommender 208 generates a recommended anomaly monitor configuration 238 based on the anomaly monitor configuration data 218 that is stored in the historical configuration database 202 for the most relevant historical configuration 236. For example, the recommended anomaly monitor configuration 238 includes a selection of backend anomaly detectors, detector parameters, thresholds, and/or anomaly alert rules (e.g., alert logic) matching those stored for the most relevant historical configuration 236.

Since different cloud service providers may be interested in different event characteristics within similar or identical datasets, the above-described comparison of the user-provided descriptions (in addition to dataset comparison) increases the likelihood that the anomaly detector recommender 208 will recommend a configuration that is a close match to the actual target configuration most suitable to needs of the cloud service provider 210.

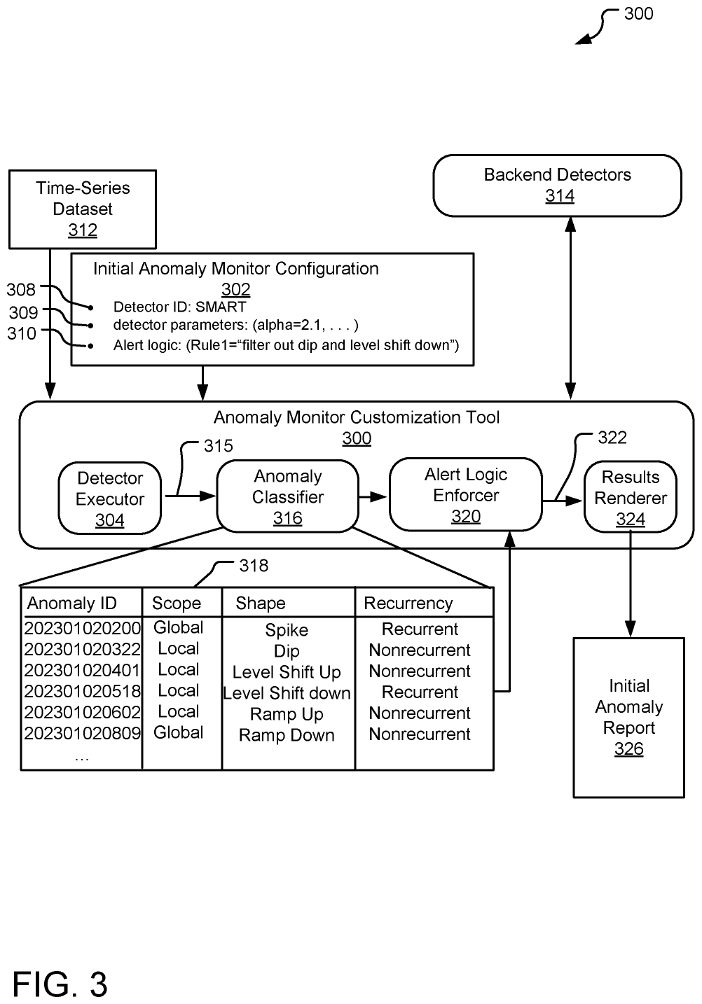

FIG. 3 illustrates aspects of an example anomaly monitor customization tool 300 to generate an initial anomaly report based on an initial anomaly monitor configuration 302. In one implementation where the anomaly monitor customization tool 300 is implemented within a system that also that recommends an initial configuration, such as the anomaly detector recommender 208 of FIG. 2, the initial anomaly monitor configuration 302 is a configuration that matches a recommended initial configuration.

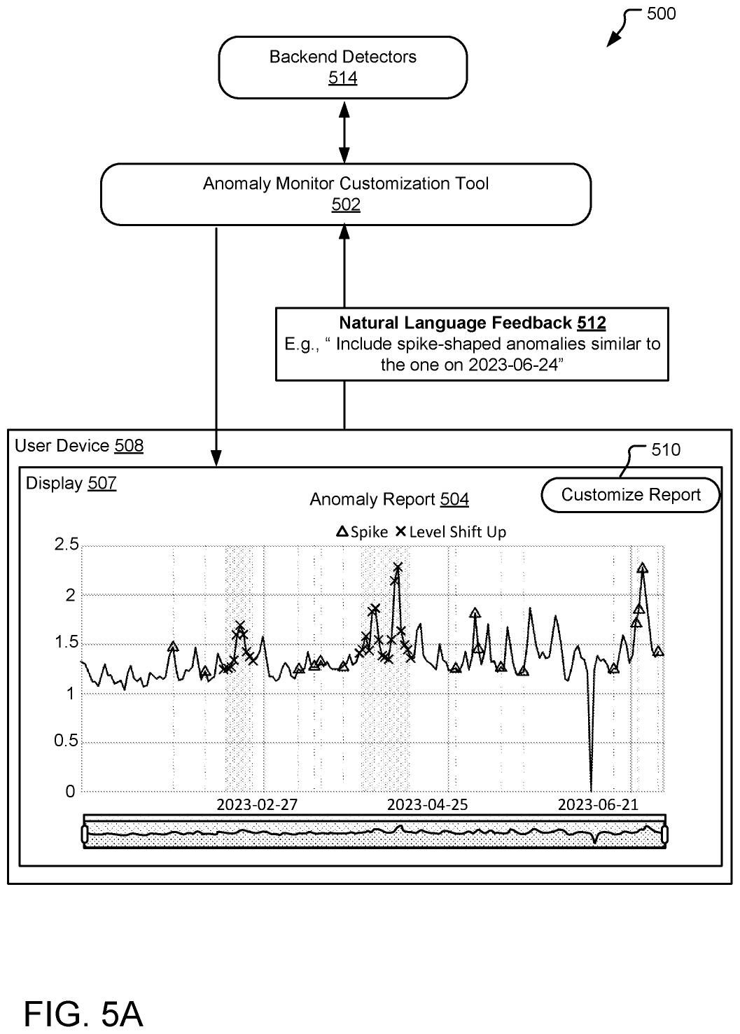

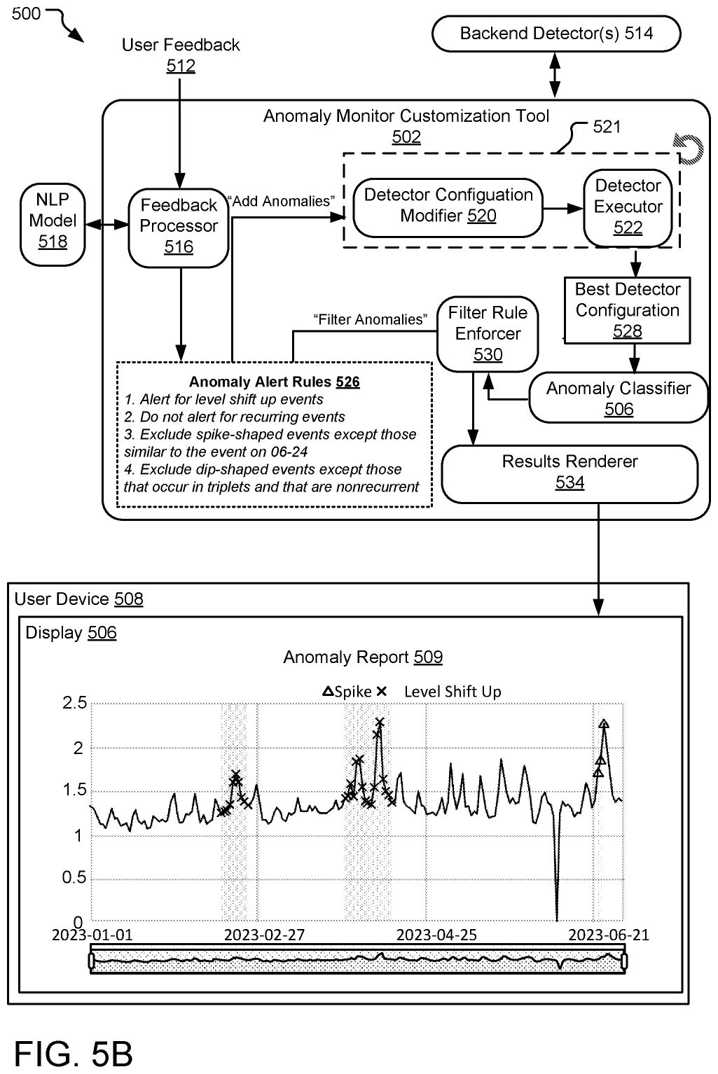

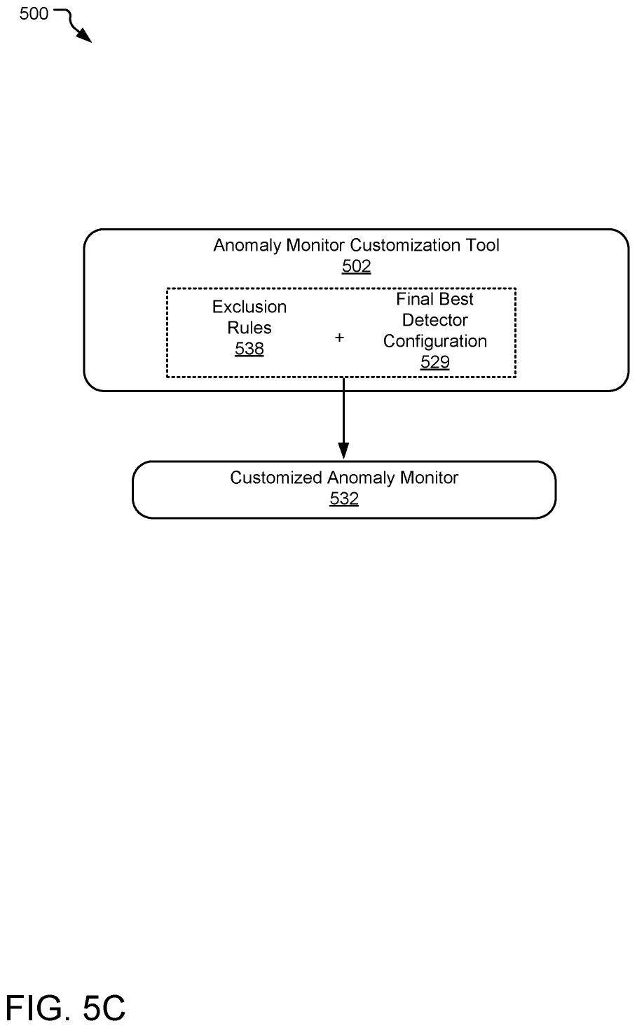

The anomaly monitor customization tool 300 drives a complex backend tuning loop that supports tuning of this initial configuration to derive a final, customized configuration of the anomaly monitor that presents a user with a report customized to the user's needs (e.g., a report that flags events characterized by features of interest to the end user). The operations described below with respect to FIG. 3 are illustrative of operations performed by the anomaly monitor customization tool 300 to generate an initial anomaly report 326 during an iterative tuning process that may subsequently provide for generation of multiple alternative versions of the initial anomaly report 326. Examples of subsequent operations performed during this same iterative tuning process and described in greater detail with respect to FIG. 5A-5C.

The initial anomaly monitor configuration 302 represents a configuration for an anomaly monitor that is defined by a selected subset of backend detectors 308, detector parameters 309, and alert logic 310. In the example of FIG. 3, the subset of backend detectors 308 includes a single detector (e.g., “SMART”) and the detector parameters 309 define various parameter values for the SMART detector. The alert logic 310 defines a single filtering rule that reads “filter out dip and level shift down,” the meaning of which is discussed in greater detail below.

This initial anomaly monitor configuration 302 is provided as an input to the anomaly monitor customization tool 300 along with a time-series dataset 312 for a performance metric. The time-series dataset 312 has characteristics consistent with other time-series datasets discussed herein. In implementations that include the anomaly detector recommender 208 of FIG. 2, the time-series dataset 312 is of the same data type (e.g., same performance metric) as that provided as input to the anomaly detector recommender 208 and may, in various implementations, be identical or different from (e.g., corresponding to a different time period) as that dataset.

Upon receipt of the time-series dataset 312 and the initial anomaly monitor configuration 302, a detector executor 304 of the anomaly monitor customization tool executes the subset of backend detectors 308 on the time-series dataset 312. The subset of backend detectors 308 output anomaly report data 315, which may be in the form of a single report or multiple reports (e.g., the event that the subset includes multiple detectors). If the anomaly report data is in the form of multiple reports, the anomaly monitor customization tool 300 modifies the anomaly report data 315 by merging the multiple reports into a single report that to be further processed (as described below) and eventually visually rendered to an end user. The anomaly report data 315 identifies a first set of events that have been flagged as anomalies by a currently-selected subset of the backend detectors 314.

The report data 315 is input to an anomaly classifier 316 along with the time-series dataset 312 (or other dataset(s) derived by the subset of backend detectors 308 based on analysis of the time-series dataset 312). The anomaly classifier 316 analyzes physical features of the received time-series data to characterize the features of each identified anomaly and, based on such characterization, classifies different characteristics of the anomaly using predefined anomaly type classifiers. Although various types of anomaly characteristics may be classified in other implementations, the anomaly classifier 316 analyzes and classifies three different characteristics for each anomaly: scope, shape, and recurrency. In general, “scope” pertains to the scale of the anomaly and describes whether the event is anomalous on a local scale (e.g., a maximum observed within a 1-day period) or on a global scale (e.g., a maximum observed over a month). “Shape” refers to the shape of the anomaly with a plot of the corresponding time-series data, and “recurrency” refers to whether the event is recurring or non-recurring within the corresponding time-series data. Examples of these characteristics are illustrated with respect to FIG. 4.

A table 318 illustrates an example of modified report data output by the anomaly classifier 316. These outputs include event identifiers (e.g., timestamps) for each event identified as anomalous by the subset of backend detectors 308 as well as anomaly type classifiers that characterize the scope, shape, and recurrency of each anomalous event.

The modified report data of table shown in the table 318 is input to an alert logic enforcer 320. The role of the alert logic enforcer 320 is to enforce the alert logic 310 defined for the current configuration of the anomaly monitor (e.g., the initial anomaly monitor configuration 302). The alert logic 310 defines various rules that each identify a subset of the anomaly type classifiers and a rule enforcement action to be performed with respect to events within the time-series dataset 312 characterized by the subset of the anomaly type classifiers. For example, the initial rule (Rule1) of the alert logic 310 indicates an enforcement action “filter” that is to be taken with respect to events in the time-series dataset that are characterized by either the anomaly type classifier “dip” or “level shift down”, both of which indicate subclassifications of the category “shape.”

Through the tuning process facilitated by the anomaly monitor customization tool 300 (discussed in greater detail with respect to FIG. 5A-5C) the alert logic 310 may be modified based on user feedback received with respect to one or more subsequent tuning iterations. In the illustrated example where the alert logic includes the rule “filter out dip and left shift down,” the alert logic enforcer 320 creates final report data 322 by modifying the report data shown in table 318 to remove the two anomalies that have shapes of “dip” and “level shift down.” The final report data 322 is provided to a results renderer 324, which presents the user with an initial anomaly report 326 which is a visual representation of the final report data 322.

FIG. 4 illustrates examples of anomaly characteristics 400 that can be classified and used to develop alert logic implemented by a customized anomaly alert monitor. Three classifiable anomaly characteristics are shown: shape 402, recurrency 404, and scope 406.

In one implementation of an anomaly monitor customization tool discussed with respect to FIG. 1 or FIG. 3, each anomaly identified by the backend anomaly detectors is characterized in terms of the characteristics illustrated in FIG. 4 (e.g., shape, recurrency, and scope) by assigning a predefined anomaly classifier to each characteristic.

The “shape” characteristic describes the shape of the event as it appears within time-series data providing a basis for the anomaly report. Although other shape-type classifiers are contemplated, FIG. 4 illustrates various predefined anomaly classifiers for the shape 402 including single spike 408, single dip 410, transient level shift up 412, transient level shift down 414, ramp up 416, and ramp up 418.

In FIG. 4, the anomaly characteristic of “recurrency” is classified using the anomaly type classifiers “recurrent” and “non-recurrent.” FIG. 4 illustrates a plot 420 illustrating examples of recurrent and non-recurrent anomalies. Recurrent means, for example, that identical or nearly-identical anomalies have occurred multiple times in the time-series data (see, e.g., recurrent versions of identical anomalies 432). Non-recurrent means that the anomaly does not appear to occur more than once.

In FIG. 4, the anomaly characteristic of “scope” is classified using the anomaly type classifiers “global” and “local.” In general, “scope” describes the scale of the anomaly with respect to whether the event is anomalous on a local scale or on a global scale. A local anomaly is characterized by one or more datapoints representing a deviation from expected trends with respect to a particular subset of the dataset (e.g., a “localized” window of time) whereas a global anomaly is characterized by one or more datapoints representing a deviation from normal trends defined with respect to the dataset as a whole. For example, a plot 422 illustrates data that follows a generally periodic pattern (repeating trend) across each of multiple consecutive time windows 424, 426, etc. Local anomalies 428 represent events that deviate from the expected pattern within the respective windows 424, 426 but that are not characterized by values that unusual on a global scale. Rather, the values of each of the local anomalies 428 are within the max/min range of expected values for corresponding interval. In contrast, global anomalies 430 represent events characterized by features that are unusual on a global scale (across the entire dataset). Specifically, the values of each of the global anomalies 430 exceed the maximum value that is expected within any individual window the dataset.

FIG. 5A illustrates operations of another example system 500 that implements an anomaly monitor customization tool 502 to drive a tuning cycling for iterative, feedback-based configuration of a customized anomaly monitor. Specific features of the anomaly monitor customization tool 502 not discussed below may be the same or similar as those described with respect to the anomaly monitor customization tool 112 of FIG. 1 or the anomaly monitor customization tool 300 of FIG. 3.

In FIG. 5A, the anomaly monitor customization tool 502 is shown communicating with backend detectors 514 and presenting an anomaly report 504 to a display 507 of a user device 508. The user device 508 is, for example, a device operated by an administrator of a cloud service provider that is configuring an anomaly monitor to perform anomaly monitoring operations of a service network of the cloud provider. During each tuning cycle of the anomaly monitor customization tool 502, a selected subset of the backend detectors 514 are executed to process a time-series dataset (e.g., performance metric) provided by the administrator. The backend detectors 514 output anomaly report data that is processed further and, eventually, presented to a user in the form of an anomaly report 504.

The anomaly report 504 includes annotations identifying a first set of events, each of which was flagged as an anomaly by one or more of the backend detectors 514. Following anomaly detection, characteristics of each identified anomaly were analyzed (e.g., by the anomaly classifier 316 of FIG. 3) and the anomalies were assigned predefined anomaly classifiers. The anomaly report 504 includes annotations indicative of some of these predefined anomaly classifiers including annotations for anomaly shape (e.g., “spike” and “level shift up”).

Notably, the anomaly report 504 may in some implementations include additional plots illustrating other performance metrics, other time-series datasets for the same performance metric, and/or other types of anomaly classifiers not shown within the anomaly report 504. It is to be appreciated that some assigned anomaly classifiers (e.g., those pertaining to scope or recurrency) may be excluded from anomaly report 504, e.g., unless requested by a user and/or unless relevant to the enforcement of certain alert rules defined based on user feedback.

When the anomaly report 504 is presented on the user display 507, the anomaly monitor customization tool 502 also presents a prompt or option for the user to provide customized feedback. In the example shown, the anomaly monitor customization tool 502 presents the user with a “customize report” button 510. When the user clicks the customize report button, the user is presented with a prompt that requests feedback from the user. In response to the prompt, the user provides feedback pertaining to discrepancies between the first set of events flagged as anomalous in the anomaly report 504 and a second set of events in the time-series data that are of interest to the user (e.g., the set of events that the user believes are anomalous and/or wishes to be included in the report).

In the illustrated example, the user feedback 512 is natural language feedback and the user types “include spike-shaped anomalies similar to the one on 2023 Jun. 24.” Other types of natural feedback can include requests to add remove anomalies from the anomaly report 504. For example, the user may type “exclude anomalies like the one on [date]” or any other natural language feedback suggestive of a modification to the list of events flagged as anomalies. In other implementations, the user provides feedback of a form other than natural language. For example, the anomaly report 504 is interactive and the user provides click-based feedback to indicate events that were flagged that the user wishes to be excluded from the report and/or events to indicate events that were not flagged as anomalies that the user wants to be included in the anomaly report 504.

The discussion of FIG. 5B highlights how the above-described types of user feedback can be interpreted and translated into alert logic used to provision a final version of the anomaly monitor for the end user.

FIG. 5B illustrates example operations performed by the anomaly monitor customization tool 502 of FIG. 5A during a single detector tuning cycle that is performed in response to receiving the user feedback 512. In the illustrated implementation, it is assumed that the user feedback 512 is natural language feedback. A feedback processor 516 transmits the user feedback 512 to a trained natural language processing (NLP) model 518, which in turn processes the feedback to infer an intent of the feedback. For example, the feedback processor 516 generates a prompt that instructs the NLP model 518 to determine whether the user is requesting an addition of anomalies, removal of anomalies, or something else.

Based on outputs of the NLP model 518, the feedback processor 516 stores one or more alert rules 526. In some implementations, the alert rules 526 are generated directly by the NLP model 518; in other implementations, the feedback processor 516 generates the alert rules based on outputs of the NLP model 518 (e.g., outputs that are, by design, standardized to a form/format expected by the feedback processor 516).

The alert rules 526 pertain to user preferences for the type(s) of events that the user does and/or does not want the anomaly monitor to flag as anomalies. Enforcement of the alert rules 526 is achieved, at least in part, by way of logical components of the anomaly monitor customization tool 502 that use the alert rules to modify anomaly configuration data that is used to provision a final anomaly monitor for the end user. As used herein, the term “modified anomaly monitor configuration data” refers to either (1) modifications to detector configuration data (e.g., defining a configuration of select backend detectors and their respective parameters or thresholds) or (2) modifications to anomaly report data generated by the backend detectors 514, such as via enforcement of alert rules 526. Detector configuration data includes the defined subset of the backend detector(s) 514 that are selectively executed as well as the respective parameters and thresholds of those selected detectors.

In the illustrated example, each one of the alert rules 526 identifies a subset of anomaly type classifiers and a rule enforcement action to be performed with respect to events within the user-provided dataset that are characterized by the subset of the anomaly type classifiers. One example of a rule enforcement action is an inclusion action that provides for including event(s) in the anomaly listing that are characterized by a corresponding subset of the anomaly type classifiers. Another example of a rule enforcement action is an exclusion action that provides for removing event(s) from the anomaly listing that are characterized by a corresponding subset of the anomaly type classifiers.

In the illustrated implementation, the alert rules 526 include some inclusion rules (e.g., “alert for all level shift up events”), some exclusion rules (e.g., “do not alert for recurring events”) and some rules that provide for a mix of inclusion and exclusion (e.g., “do not alert for spike-shaped events except those similar to the event on June 24” and “exclude dip-shaped anomalies except those that occur in triplets and that are nonrecurrent”).

Following receipt of the user feedback 512 and updates to the alert rules 526 based on the use feedback 512, a tuning cycle commences. Each tuning cycle of the anomaly monitor customization tool 502 provides for two alert rule enforcement stages. First, inclusion rules are enforced by updating the detector configuration data to provide for better “inclusion” (e.g., anomaly flagging) of the events referenced by the corresponding inclusion rule. Per this methodology, inclusion rules may each be enforced a single time during a single, corresponding tuning cycle and may not need to be stored or re-enforced during each subsequent tuning cycle of the anomaly monitor customization tool 502. In contrast to inclusion rules, exclusion rules are enforced at the end of each tuning cycle of the anomaly monitor customization tool 502 (e.g., following the updates to the detector configuration data) by filtering anomaly report data generated by the currently-selected detector configuration (e.g., a “best detector configuration 528”, as shown in FIG. 5B). Therefore, exclusion rules may be re-enforced anew during each subsequent tuning cycle and also re-enforced during each execution instance of a customized anomaly monitor (not shown) that is provisioned based anomaly monitor configuration data derived during the tuning cycles.

In each feedback-based tuning cycle of the anomaly monitor customization tool 502, each newly-added inclusion rule is enforced by executing an “add anomalies” function. Inputs to the “add anomalies” function include, for example, identifiers for new anomalies of interest, such as dates corresponding to event(s) that the user wants added to the anomaly listing and/or characteristics of the events that the user wants included in the anomaly listing (e.g., characteristics corresponding to predefined anomaly classifiers such as those described with respect to FIG. 3-4). The “add anomalies” function triggers execution of an iterative loop 521 that provides for iteratively updating the detector configuration data to identify a configuration of the anomaly monitor that performs better with respect to flagging the events of interest as anomalies. During each iteration of the loop 521, a detector configuration modifier 520 modifies the detector configuration data and a detector executor 522 re-executes the (updated) selection of the backend detectors 514 according to the modified detector configuration data. A performance metric (not shown) is then calculated to measure whether, and how well (if applicable), the new inclusion rule was enforced.

Assume, for example, the user feedback includes the instruction: “include events like the one on 2023 Apr. 14.” Upon processing this feedback, the NLP model 518 affirms that this feedback should be interpreted as a request to add an anomaly corresponding to an event on 2023 Apr. 14, and the feedback processor 516 further analyzes this event to determine the event is a level shift up shape. From this, the feedback processor 516 generates the rule “alert for all level shift up events.” Following generation of this new alert rule, the feedback processor 516 analyzes the user dataset (e.g., without executing any of the backend detectors 514) to identify a subset of target events in the user-provided dataset that satisfy the alert rule—e.g., the subset of events that are classified by a “lateral shift up” shape. The detector configuration modifier 520 iteratively modifies the detector configuration data and re-executes anomaly detectors according to thresholds and parameters defined by the modified detector configuration data in an effort to identify a detector configuration that is highest-performing with respect to successfully flagging this subset of target events an anomalies.

The loop 521 is repeated cyclically until an end condition is satisfied, such as in response to determining that the alert rule has been enforced to within a predefined acceptable margin of error or until the expiration of a time limit or a set number of iterations. For each “add anomalies” function instance, a best-performing detector configuration is identified—“the best detector configuration 528”—and a currently-selected detector configuration is updated based on (e.g., to match) the best detector configuration 528.

Anomaly report data generated by the currently-selected detector configuration is analyzed by an anomaly classifier 506, which assigns predefined anomaly classifications to each anomaly, such as in the manner described with respect to FIG. 3-4. Following this anomaly classification, a filter rule enforcer 530 executes a “filter anomalies” function with respect to each exclusion rule included in the alert rules 526. Execution of each instance of the “filter anomalies” function is enforced by selectively modifying the anomaly report data generated by the currently-selected detector configuration to filter (remove) select anomalies.

In the illustrated example, the filer rule enforcer 530 enforces rule #2 of the alert rules 526 (e.g., “do not alert for recurring events”) by modifying anomaly report data output by the best detector configuration 528 to remove anomaly alerts generated for anomalies assigned to a classification type “recurrent.”

As mentioned above, some of the alert rule 526 may provide for a combination of inclusion and exclusion. In one implementation, these inclusion/exclusion combination rules are enforced by executing complementary instances of the “add anomalies” and “filter anomalies” functions. For example, rule #3 in the illustrated example (e.g., “exclude spike-shaped events except those similar to the event on June 24”) is inclusionary in the sense that it depends upon proper identification of some spike-shaped anomalies, and this rule is also exclusionary in the sense that spike-shaped anomalies are not to be identified as anomalies unless they are similar to the event on June 24 by some predefined similarity criteria. In one implementation, this rule is enforced by executing complementary “add anomalies” and “filter anomalies” functions. For example, an instance of the “add anomalies” function is executed ensure the selected detector configuration (e.g., the best detector configuration 528) is capable of identifying all anomalies potentially satisfying the rule (e.g., spike-shaped anomalies). Following selection of the best detector configuration 528, a complimentary “filter anomalies” function is then executed order to remove anomaly flags in the anomaly report data generated by the best detector configuration 528 for a subset of events that have been assigned the “spike-shaped” classification and that are also deemed similar to the June 24 event, such as based on assessment of predefined similarity criteria that defines ranges of values for shape characteristics that are to be considered “similar” (e.g., full-width half max (FWHM), slope up, slope down).

Following enforcement of each exclusion rule by execution a corresponding instance of the “filter anomalies” function, a results renderer 534 renders an updated anomaly report 509 to the user display. In the illustrated example, the updated anomaly report 509 differs from the anomaly report 504 (in FIG. 5A) in that the spike-shaped anomalies have been filtered except for the June 24 event, as a result of rule #3. In this example, the anomaly report 509 does not illustrate specific changes stemming from the enforcement of rules #1, 2, or #4, and rules are largely provided as examples of the types of rules that could (if applicable to the dataset) serve as a basis for changes to the anomaly report 504.

In various implementations, the NLP model 518 has different characteristics and is, for example, a transformer-based model such as a generative pre-trained transformer (GPT) model, a sequential model, or a recurrent neural network (RNN). In one implementation, the NLP model 518 is a model specifically trained (or refined) based on a dataset including examples of inputs (e.g., user-provided natural language feedback) and outputs (e.g., alert rules generated based on the user feedback or function calls to enforce the alert rules).

In another implementation, the NLP model 518 is an off-the shelf large language model (LLM), such as GPT-3 or GPT-4, BERT, or sequence-to-sequence model, and the feedback processor 516 prepares an LLM prompt that includes examples of the task that the NLP model 518 is to perform. For example, the prompt provided to the NLP model 518 includes three or more examples of user-provided natural language feedback and corresponding example model outputs.

The feedback-driven tuning cycle described with respect to FIG. 5A-5B is, in various implementations, repeated any number of times such as until the user ceases to provide additional feedback and/or provides an input indicating satisfaction with the anomaly report (e.g., 504, 506) generated during the previous iteration of the tuning cycle.

FIG. 5C illustrates example operations of the anomaly monitor customization tool 502 of FIGS. 5A and 5B for provisioning a customized anomaly monitor for the end user based on one or more iterations of the feedback-driven tuning cycle discussed with respect to FIGS. 5A and 5B. At this point in time, a final best detector configuration 529 has been identified and stored. The final best detector configuration 529 may be identical to the best detector configuration 528 of the tuning cycle shown in FIG. 5B or modified, such as in an implementation where one or more additional tuning cycles are implemented following the tuning cycle illustrated in FIG. 5B (in which case, the final best detector configuration matches a most-recent version of the best detector configuration 528).

The final best detector configuration 529 defines a selection of the backend detectors 514 and corresponding detector parameters and/or thresholds collectively determined to provide satisfactory enforcement of all inclusion rules generated during the feedback-driven tuning cycles for anomaly monitor the user is presently requesting. The anomaly monitor customization tool 502 also stores a complete listing of exclusion rules 538. The exclusion rules 538 are intended to include a subset of the alert rules 526 (shown in FIG. 5B) that are exclusionary and that are generated during the feedback-driven tuning cycle(s) for the anomaly monitor the user is requesting.

The anomaly monitor customization tool 502 provisions an instance of a customized anomaly monitor 532 for the user based on the final best detector configuration 529 and the exclusion rules 538. The customized anomaly monitor 532 executes a selected subset of backend detectors identified by the final best detector configuration 529 in accordance with the detector parameters and/or detector thresholds specified by the final best detector configuration 529. Additionally, the anomaly monitor customization tool 502 includes logic that enforces the exclusion rules 538 on the outputs of the selected subset of backend detectors.

In some implementations, the customized anomaly monitor 532 is subjected to AI-driven fine-tuning of detector parameters and thresholds. For example, a machine learning (ML) model can be configured to implement logic of the customized anomaly monitor and provided with additional time-series datasets from the same user along. During this fine-tuning, the ML model implements a training cycle that provides for (1) processing each additional time-series dataset; (2) comparing model outputs to corresponding user-provided anomaly label information (e.g., indicating events that the user views as anomalies); (3) computing a loss function; and (4) updating model weights (e.g., tuning the detector parameters and thresholds) based on the loss function. While this additional ML-based tuning can significantly improve detector performance, some implementations provide for implementation of the customized anomaly monitor 532 without performing any additional tuning.

In some aspects, the techniques described herein relate to a system including: an anomaly monitor customization tool stored in memory and executable to: execute an instance of an anomaly monitor, the instance defining a selected subset of backend anomaly detectors to process a time-series dataset for a performance metric; receive, as output from the instance of the anomaly monitor, anomaly report data identifying a first set of events included in the time-series dataset and flagged as anomalies; characterize the anomalies by assigning anomaly type classifiers; based on feedback pertaining to discrepancies between the first set of events flagged as anomalies and a second set of events in the time-series dataset that are of interest, define an alert rule that identifies a subset of the anomaly type classifiers and a rule enforcement action to be performed with respect to events within the time-series dataset characterized by the subset of the anomaly type classifiers; based on the alert rule, generate modified configuration data for the anomaly monitor; and provision a customized anomaly monitor based on the modified configuration data.

In some aspects, the techniques described herein relate to a system, wherein the anomaly monitor executes the selected subset of backend anomaly detectors based on a selected configuration of detector parameters and detection thresholds and wherein generating the modified configuration data includes altering at least one of: the selected subset of backend anomaly detectors; and the detector parameters; or the detection thresholds.

In some aspects, the techniques described herein relate to a system, wherein the anomaly monitor customization tool is further configured to: based on the feedback, determine that the first set of events excludes a particular event of interested; in response to the feedback, execute multiple instances of the anomaly monitor to identify a detector configuration for the anomaly monitor that successfully identifies the particular event as an anomaly, each of the multiple instances being executed in response to a modification to the detector configuration; identify a select detector configuration corresponding to one of multiple instances of the anomaly monitor that identifies the particular event as an anomaly; and solicit additional feedback pertaining to a version of the anomaly report data generated based on the select detector configuration.

In some aspects, the techniques described herein relate to a system, wherein the alert rule provides for identifying an event as an anomaly if the event is characterized by the subset of the anomaly type classifiers.

In some aspects, the techniques described herein relate to a system, wherein the alert rule provides for not flagging an event as an anomaly if the event is characterized by the subset of the anomaly type classifiers.

In some aspects, the techniques described herein relate to a system, wherein the anomaly type classifiers identify at least one of a shape, scope, and recurrency of an anomaly.

In some aspects, the techniques described herein relate to a system, wherein the feedback is natural language feedback and the anomaly monitor customization tool is further configured to: utilize a trained natural language processing (NLP) model to infer intent from the feedback; and define the alert rule based on the intent.

In some aspects, the techniques described herein relate to a method including: executing a first instance of an anomaly monitor, the first instance defining a selected subset of backend anomaly detectors to process a dataset including a time-series dataset for a performance metric sampled within a cloud provider network; receiving, as output from the selected subset of backend anomaly detectors, anomaly report data identifying a first set of events included in the time-series dataset and flagged as anomalous; analyzing physical characteristics of the time-series dataset to assign a subset of anomaly type classifiers to events of the first set of events; based on feedback pertaining to discrepancies between the first set of events flagged as anomalous in the anomaly report data and a second set of events in the time-series dataset that are of interest, defining an alert rule that identifies a subset of the anomaly type classifiers and a rule enforcement action to be performed with respect to events within the time-series dataset characterized by the subset of the anomaly type classifiers; based on the alert rule, generating modified configuration data for the anomaly monitor; and provision a customized anomaly monitor for use within the cloud provider network and in accordance with the modified configuration data.

In some aspects, the techniques described herein relate to a method, wherein executing the selected subset of backend anomaly detectors is based on a selected configuration of detector parameters and detection thresholds and wherein generating the modified configuration data includes altering at least one of: the selected subset of backend anomaly detectors; the detector parameters; or the detection thresholds.

In some aspects, the techniques described herein relate to a method, further including: based on the feedback, determine that the first set of events excludes a particular event that a user is interested in; in response to the feedback, execute multiple instances of the anomaly monitor to identify a detector configuration for the anomaly monitor that successfully identifies the particular event as an anomaly, each of the multiple instances being executed in response to a modification to the detector configuration; identify a select detector configuration corresponding to one of multiple instances of the anomaly monitor that identifies the particular event as an anomaly; and solicit additional feedback pertaining to a version of the anomaly report data generated based on the select detector configuration.

In some aspects, the techniques described herein relate to a method, wherein the alert rule provides for identifying an event as an anomaly if the event is characterized by the subset of the anomaly type classifiers.

In some aspects, the techniques described herein relate to a method, wherein the subset of the anomaly type classifiers classify at least one of a shape, scope, and recurrency of an anomaly.

In some aspects, the techniques described herein relate to a method, wherein the alert rule provides for not flagging an event as an anomaly if the event is characterized by the subset of the anomaly type classifiers.

In some aspects, the techniques described herein relate to a method, wherein the feedback is natural language feedback and the method further includes: utilizing a natural language model to infer intent from the feedback and to define the alert rule based on the intent.

In some aspects, the techniques described herein relate to a system including: an anomaly detector recommender stored in memory and executable to: receive inputs including a time-series dataset and a description of the time-series dataset; and based on the inputs and historical configurations stored with respect to past instances of an anomaly monitor, generate a recommendation that includes: a recommended backend anomaly detector to be executed by the anomaly monitor; and an initial set of alert rules to be enforced by the anomaly monitor, each of the alert rules identifying an anomaly characteristic and a rule enforcement action be taken by with respect to events within the time-series dataset characterized by the anomaly characteristic.

In some aspects, the techniques described herein relate to a system, wherein the historical configurations each define past inputs received in association with a past instance of the anomaly monitor, and wherein the anomaly detector recommender compares the inputs to the past inputs of each of the historical configurations to identify a most relevant historical configuration.

In some aspects, the techniques described herein relate to a system, wherein the historical configurations each define a historical set of anomaly alert rules implemented in association with a past instance of the anomaly monitor, and wherein the initial set of alert rules matches the historical set of anomaly alert rules defined for the most relevant historical configuration.

In some aspects, the techniques described herein relate to a system, wherein generation of the recommendation includes: vectorizing the time-series dataset and a historical time-series dataset stored in association with each of the historical configurations; vectorizing the description and a historical description stored in association with each of the historical configurations; for each configuration of the historical configurations; computing a semantic similarity metric quantifying similarity between the description and the historical description for the configuration; computing a time-series similarity metric quantifying similarity between the time-series dataset and the historical time-series dataset for the configuration; and calculating an overall similarity metric for the configuration that is based on both the semantic similarity metric and the time-series similarity metric; selecting, based on the overall similarity metric computed with respect to each of the historical configurations, a most relevant historical configuration; and generating the recommendation based on the most relevant historical configuration.

In some aspects, the techniques described herein relate to a system, wherein the system further includes an anomaly monitor customization tool that tunes parameters and thresholds of the recommended backend anomaly detector to enforce the initial set of alert rules.

In some aspects, the techniques described herein relate to a system, wherein the time-series dataset represents a service metric and the description identifies the service metric.

In some aspects, the techniques described herein relate to a system comprising: a means for executing a first instance of an anomaly monitor, the first instance defining a selected subset of backend anomaly detectors to process a dataset including a time-series dataset for a performance metric sampled within a cloud provider network; a means for receiving, as output from the selected subset of backend anomaly detectors, anomaly report data identifying a first set of events included in the time-series dataset and flagged as anomalous; a means for analyzing physical characteristics of the time-series dataset to assign a subset of anomaly type classifiers to events of the first set of events; a means for defining an alert rule that identifies a subset of the anomaly type classifiers and a rule enforcement action to be performed with respect to events within the time-series dataset characterized by the subset of the anomaly type classifiers based on feedback pertaining to discrepancies between the first set of events flagged as anomalous in the anomaly report data and a second set of events in the time-series dataset that are of interest; a means for generating modified configuration data for the anomaly monitor based on the alert rule; and a means for provisioning a customized anomaly monitor for use within the cloud provider network and in accordance with the modified configuration data.

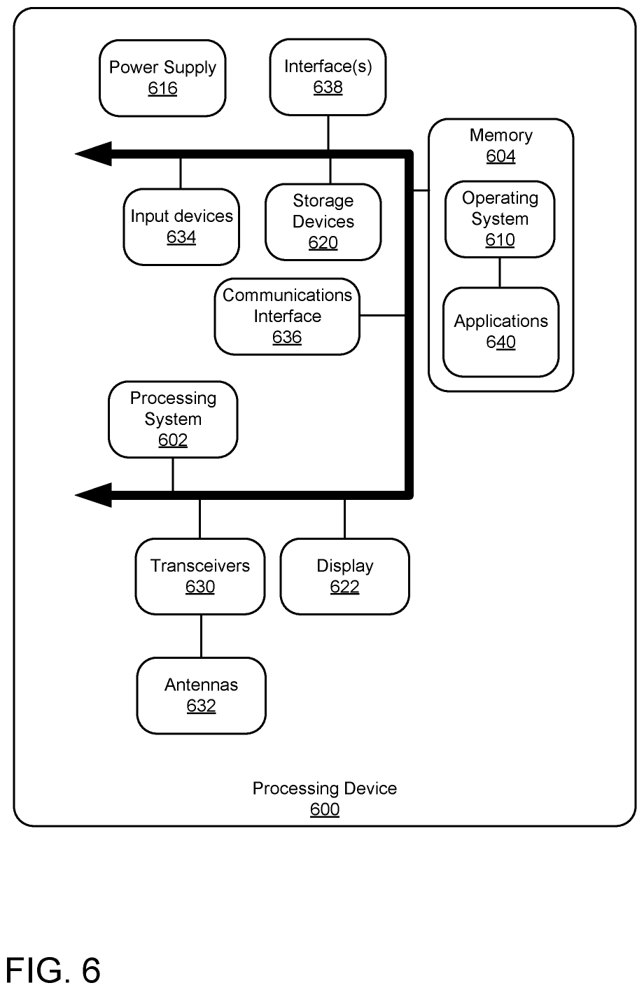

FIG. 6 illustrates an example schematic of a processing device 600 suitable for implementing aspects of the disclosed technology. The processing device 600 includes a processing system 602, memory device(s) 604, a display 622, and other interfaces 638 (e.g., buttons). The processor unit(s) 602 may each include one or more computer processing units (CPUs), graphics processing units (GPUs), etc.

The memory 604 generally includes both volatile memory (e.g., random access memory (RAM)) and non-volatile memory (e.g., flash memory). An operating system 610 resides in the memory 604 and is executed by the processing system 602. One or more applications 640 (e.g., the anomaly detector recommender 108 or 208, the anomaly monitor customization tool 112, 300, 502) are loaded in the memory 604 and executed on the operating system 610 by the processing system 602. In some implementations, aspects of the monitor recommendation and customization tool 106 of FIG. 1 are loaded into memory of different processing devices connected across a network. The applications 640 may receive inputs from one another as well as from various input local devices 634 such as a microphone, input accessory (e.g., keypad, mouse, stylus, touchpad, gamepad, racing wheel, joystick), or a camera.

Additionally, the applications 640 may receive input from one or more remote devices, such as remotely-located servers or smart devices, by communicating with such devices over a wired or wireless network using more communication transceivers 630 and an antenna 632 to provide network connectivity (e.g., a mobile phone network, Wi-Fi®, Bluetooth®). The processing device 600 may also include one or more storage devices 620 (e.g., non-volatile storage). Other configurations may also be employed. In one implementation, the significant cohort identifier 217 of FIG. 2 is an application executing on the processing device 600 or as a distributed application with different components executing on many different devices. The significant cohort identifier connects to a centralized telemetry storage repository over a network that stores telemetry data from many different devices.

The processing device 600 further includes a power supply 616, which is powered by one or more batteries or other power sources and which provides power to other components of the processing device 600. The power supply 616 may also be connected to an external power source (not shown) that overrides or recharges the built-in batteries or other power sources.

The processing device 600 may include a variety of tangible computer-readable storage media and intangible computer-readable communication signals. Tangible computer-readable storage can be embodied by any available media that can be accessed by the processing device 600 and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes RAM, read-only memory (ROM), electrically erasable programmable read-only memory (EEPROM), flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 600. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, radio frequency (RF), infrared and other wireless media.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

1. A system comprising:
an anomaly monitor customization tool stored in memory and executable to:
execute an instance of an anomaly monitor, the instance defining a selected subset of backend anomaly detectors to process a time-series dataset for a performance metric;
receive, as output from the instance of the anomaly monitor, anomaly report data identifying a first set of events included in the time-series dataset and flagged as anomalies;
characterize the anomalies flagged by the anomaly monitor by assigning anomaly type classifiers, at least some of the anomaly type classifiers describing different anomaly shapes that appear within a visualization of the time-series dataset;
define an alert rule based on user feedback pertaining to discrepancies between the first set of events flagged as anomalies and a second set of events in the time-series dataset that are of interest to a user, the alert rule identifying:
at least one anomaly classifier of the anomaly type classifiers describing one or more of the different anomaly shapes assigned to the characterized anomalies; and
a rule enforcement action to be performed with respect to events within the time-series dataset characterized by the at least one anomaly classifier of the anomaly type classifiers;
in response to defining the alert rule, iteratively update detector configuration data to identify modified configuration data for the anomaly monitor that performs better with respect to enforcement of the alert rule on the time-series dataset; and
provision a customized anomaly monitor based on the modified configuration data.

2. The system of claim 1, wherein the anomaly monitor executes the selected subset of backend anomaly detectors based on a selected configuration of detector parameters and detection thresholds and wherein generating the modified configuration data includes altering at least one of:
the selected subset of backend anomaly detectors; and
the detector parameters; or
the detection thresholds.

3. The system of claim 1, wherein the anomaly monitor customization tool is further configured to:
based on the user feedback, determine that the first set of events excludes a particular event of interested;
in response to the user feedback, execute multiple instances of the anomaly monitor to identify a detector configuration for the anomaly monitor that successfully identifies the particular event as an anomaly, each of the multiple instances being executed in response to a modification to the detector configuration;
identify a select detector configuration corresponding to one of multiple instances of the anomaly monitor that identifies the particular event as an anomaly; and
solicit additional user feedback pertaining to a version of the anomaly report data generated based on the select detector configuration.

4. The system of claim 1, wherein the alert rule provides for identifying an event as an anomaly if the event is characterized by the select anomaly classifier of the anomaly type classifiers.

5. The system of claim 1, wherein the alert rule provides for not flagging an event as an anomaly if the event is characterized by the select anomaly classifier of the anomaly type classifiers.

6. The system of claim 1, wherein the anomaly type classifiers identify at least one of a shape, scope, and recurrency of an anomaly.

7. The system of claim 1, wherein the user feedback is natural language feedback and the anomaly monitor customization tool is further configured to:
utilize a trained natural language processing (NLP) model to infer intent from the user feedback; and
define the alert rule based on the intent.

8. A method comprising:
executing a first instance of an anomaly monitor, the first instance defining a selected subset of backend anomaly detectors to process a dataset including a time-series dataset for a performance metric sampled within a cloud provider network;
receiving, as output from the selected subset of backend anomaly detectors, anomaly report data identifying a first set of events included in the time-series dataset and flagged as anomalous;
analyzing physical characteristics of the time-series dataset to assign a subset of anomaly type classifiers to events of the first set of events flagged as anomalous by the anomaly monitor, at least some of the anomaly type classifiers describing different anomaly shapes that appear within a visualization of the time-series dataset;
defining an alert rule based on user feedback pertaining to discrepancies between the first set of events flagged as anomalous in the anomaly report data and a second set of events in the time-series dataset that are of interest, the alert rule identifying:
at least one of the anomaly type classifiers describing one or more of the different anomaly shapes assigned to the characterized anomalies; and
a rule enforcement action to be performed with respect to events within the time-series dataset characterized by the at least one of the anomaly type classifiers;
based on the alert rule, iteratively updating detector configuration data to identify modified configuration data for the anomaly monitor that performs better with respect to enforcement of the alert rule on the time-series dataset; and
provision a customized anomaly monitor for use within the cloud provider network and in accordance with the modified configuration data.

9. The method of claim 8, wherein executing the selected subset of backend anomaly detectors is based on a selected configuration of detector parameters and detection thresholds and wherein generating the modified configuration data includes altering at least one of:
the selected subset of backend anomaly detectors;
the detector parameters; or
the detection thresholds.

10. The method of claim 8, further comprising:
based on the user feedback, determine that the first set of events excludes a particular event that a user is interested in;
in response to the user feedback, execute multiple instances of the anomaly monitor to identify a detector configuration for the anomaly monitor that successfully identifies the particular event as an anomaly, each of the multiple instances being executed in response to a modification to the detector configuration;
identify a select detector configuration corresponding to one of multiple instances of the anomaly monitor that identifies the particular event as an anomaly; and
solicit additional user feedback pertaining to a version of the anomaly report data generated based on the select detector configuration.

11. The method of claim 8, wherein the alert rule provides for identifying an event as an anomaly if the event is characterized by the at least one of the anomaly type classifiers.

12. The method of claim 8, wherein the at least one of the anomaly type classifiers classify at least one of a shape, scope, and recurrency of an anomaly.

13. The method of claim 8, wherein the alert rule provides for not flagging an event as an anomaly if the event is characterized by the at least one of the anomaly type classifiers.

14. The method of claim 8, wherein the user feedback is natural language feedback and the method further comprises:
utilizing a natural language model to infer intent from the user feedback and to define the alert rule based on the intent.

15. A system comprising:
an anomaly detector recommender stored in memory and executable to:
receive inputs including a time-series dataset and a description of the time-series dataset;
accessing historical configurations stored with respect to past instances of an anomaly monitor, the historical configurations including historical time-series data and a description stored in association with each of the historical configurations;
based on the inputs and the historical configurations stored with respect to past instances of the anomaly monitor, generate a recommendation that includes:
a recommended backend anomaly detector to be executed by the anomaly monitor; and
an initial set of alert rules to be enforced by the anomaly monitor, each of the alert rules identifying an anomaly characteristic and a rule enforcement action to be taken by with respect to events within the time-series dataset characterized by the anomaly characteristic.

16. The system of claim 15, wherein the historical configurations each define past inputs received in association with a past instance of the anomaly monitor, and wherein the anomaly detector recommender compares the inputs to the past inputs of each of the historical configurations to identify a most relevant historical configuration.

17. The system of claim 16, wherein the historical configurations each define a historical set of anomaly alert rules implemented in association with a past instance of the anomaly monitor, and wherein the initial set of alert rules matches the historical set of anomaly alert rules defined for the most relevant historical configuration.

18. The system of claim 15, wherein generation of the recommendation includes:
vectorizing the time-series dataset and a historical time-series dataset stored in association with each of the historical configurations;
vectorizing the description and a historical description stored in association with each of the historical configurations;
for each configuration of the historical configurations;
computing a semantic similarity metric quantifying similarity between the description and the historical description for the configuration;
computing a time-series similarity metric quantifying similarity between the time-series dataset and the historical time-series dataset for the configuration; and
calculating an overall similarity metric for the configuration that is based on both the semantic similarity metric and the time-series similarity metric;
selecting, based on the overall similarity metric computed with respect to each of the historical configurations, a most relevant historical configuration; and
generating the recommendation based on the most relevant historical configuration.

19. The system of claim 15, wherein the system further comprises an anomaly monitor customization tool that tunes parameters and thresholds of the recommended backend anomaly detector to enforce the initial set of alert rules.

20. The system of claim 15, wherein the time-series dataset represents a service metric and the description identifies the service metric.

21. The system of claim 15, wherein at least two alert rules of the set of initial alert rules included in the recommendation respectively identify different anomaly type classifiers that describe different anomaly shape that appear within a visualization of the time-series dataset and rule enforcement actions to be performed with respect to events within the time-series dataset characterized by the different anomaly type classifiers.
